(19) United States
(12) Patent Application Publication
(10) Pub. No.: US 2013/0151117 A1
(43) Pub. Date: Jun. 13, 2013

(54) METHOD OF DETERMINING WATER CONTENT OF ETHANOL FOR FFV AND CORRECTING FUEL QUANTITY BASED ON WATER CONTENT

(71) Applicant: Jin Woo KIM, Gunpo-si (KR)

(72) Inventor: Jin Woo KIM, Gunpo-si (KR)

(73) Assignees: Kia Motors Corp., Seoul (KR); Hyundai Motor Company, Seoul (KR)

(21) Appl. No.: 13/536,546

(22) Filed: Jun. 28, 2012

(30) Foreign Application Priority Data
Dec. 8, 2011 (KR) 10-2011-0130854

(51) Int. Cl. F02D 28/00; F02D 41/30; F02D 41/26

(52) U.S. Cl. 701/103; 701/101

(57) ABSTRACT

A method of determining the water content of ethanol for an FFV and correcting fuel quantity based on the water content, which verifies whether an oxygen sensor is normal or abnormal, and it is determined whether ethanol learning conditions have been satisfied. It is determined whether learned concentration of ethanol is 100%. If the oxygen sensor is normal, the ethanol learning conditions are satisfied, and the ethanol concentration is 100%, it is determined that water is contained in the ethanol if a quantity of fuel learned by the oxygen sensor is greater than a predetermined reference value. If it is determined that water is contained in the ethanol, water content corresponding to the learned quantity of fuel is calculated from a map of water contents correlated with learned fuel quantities.

### CROSS-REFERENCE TO RELATED APPLICATIONS

The present application claims priority of Korean Patent Application Number 10-2011-0130854 filed on Dec. 8, 2011, the entire contents of which application is incorporated herein for all purposes by this reference.

### BACKGROUND OF INVENTION

1. Field of Invention

The present invention relates to technologies for determining the water content of ethanol and correcting the quantity of fuel to be injected based on the determined water content, in a Flexible Fuel Vehicle (FFV) that uses ethanol, thus ensuring the smooth operability of an engine.

2. Description of Related Art

Due to the sudden world-wide increase in the price of crude oil, the demand for the relatively cheaper ethanol fuel compared to gasoline has suddenly increased in Brazil, China, Southeast Asia, the United States, etc. Technology for Flexible Fuel Vehicles (FFVs) that can use such ethanol fuel has been developed.

Ethanol used in FFVs has a theoretical air-fuel ratio of 9:1 and requires a larger quantity of fuel than does gasoline. In such a vehicle, the ethanol concentration of fuel is learned and the quantity of fuel is corrected depending on the ethanol concentration, thus enabling an engine to be smoothly driven using a fuel mixture of ethanol and gasoline, or using only the fuel of 100% ethanol.

However, ethanol typically contains water. It is reported that in Brazil the ethanol contains about 7 to 15% water. When water is contained in such ethanol used as fuel, a substantial air-fuel ratio varies with the water content. Therefore, unless the water content is properly corrected, the operability of the engine varies, the discharge characteristics of harmful substances are changed, and there is the probability of resulting in misdiagnosis in a procedure for monitoring a fuel system, depending on the degree to which the air-fuel ratio is offset.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present application has been made keeping in mind the above problems occurring in the prior art, and an aspect of the present application is to provide a method of determining the water content of ethanol for an FFV and correcting the quantity of fuel based on the water content, which determines the water content of ethanol, corrects the quantity of fuel based on the water content, and is capable of obtaining an appropriate air-fuel ratio substantially adapted to an engine, so that the soft operability of the engine can be ensured, the discharge of harmful substances can be reduced, and misdiagnoses can be prevented from occurring in a procedure for monitoring a fuel system, thus improving the reliability and marketability of the FFV.

One aspect of the present application is directed to provide a method of determining water content of ethanol for a Flexible Fuel Vehicle (FFV), including a) verifying whether an oxygen sensor is normal or abnormal, and determining whether ethanol learning conditions have been satisfied; b) determining whether learned concentration of ethanol is 100%; c) if the oxygen sensor is normal, the ethanol learning conditions are satisfied, and the ethanol concentration is 100%, determining that water is contained in the ethanol when a quantity of fuel learned by the oxygen sensor is greater than a predetermined reference value; and d) if it is determined in c) that water is contained in the ethanol, calculating water content corresponding to the learned quantity of fuel from a map of water contents correlated with learned fuel quantities.

Another aspect of the present application is directed to provide a method of determining water content of ethanol for a Flexible Fuel Vehicle (FFV) and correcting fuel quantity based on the water content, including a) verifying whether an oxygen sensor is normal or abnormal, and determining whether ethanol learning conditions have been satisfied; b) determining whether learned concentration of ethanol is 100%; c) if the oxygen sensor is normal, the ethanol learning conditions are satisfied, and the ethanol concentration is 100%, determining that water is contained in the ethanol when a quantity of fuel learned by the oxygen sensor is greater than a predetermined reference value; d) if it is determined in c) that water is contained in the ethanol, calculating water content corresponding to the learned quantity of fuel from a map of water contents correlated with learned fuel quantities; and e) comparing the water content calculated in d) with a map of basic fuel quantities corresponding to water contents, obtaining a basic quantity of fuel corresponding to the water content calculated in d), and injecting the fuel based on the basic quantity of fuel.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating an exemplary method of determining the water content of ethanol for an FFV according to the present application.

FIG. 2 is a flowchart illustrating an exemplary method of determining the water content of ethanol for an FFV and correcting fuel quantity based on the water content according to the present application.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

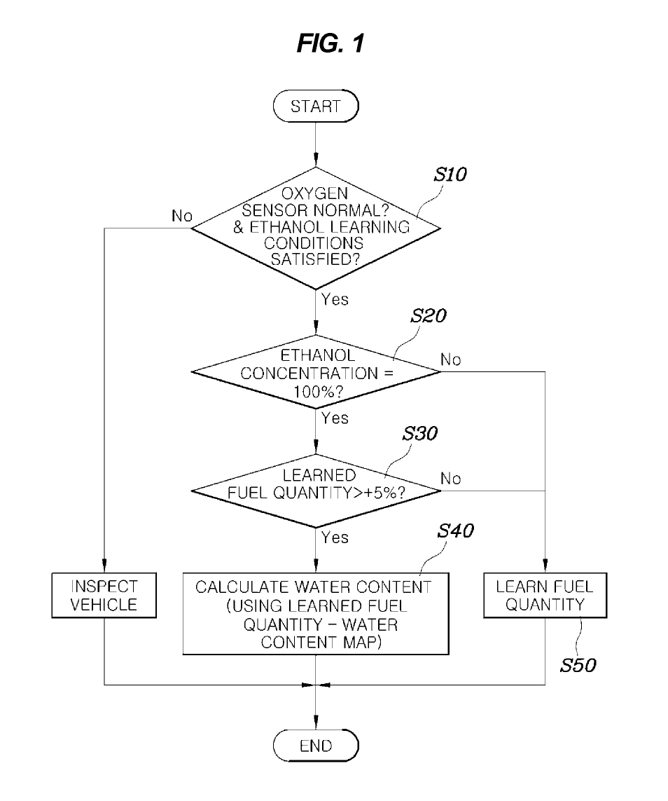

Referring to FIG. 1, various embodiments of the method of determining the water content of ethanol for an FFV according to the present application includes a preliminary condition verification step S10, an ethanol determination step S20, a water content determination step S30, and a water content calculation step S40. In step S10, whether an oxygen sensor is normal or abnormal is verified, and whether ethanol learning conditions have been satisfied is determined. In step S20, whether learned concentration of the ethanol is 100% is determined. In step S30, in the case where the oxygen sensor is normal, the ethanol learning conditions have been satisfied, and the ethanol concentration is 100%, it is determined that water is contained in the ethanol if the quantity of fuel learned, detected or determined by the oxygen sensor is greater than a predetermined reference value. In step S40, if it is determined in the water content determination step S30 that water is contained in the ethanol, water content corresponding to the learned quantity of fuel is obtained from a map of water contents correlated with learned fuel quantities.

That is, in the case where the oxygen sensor is normal, the predetermined ethanol learning conditions have been satisfied, and the learned ethanol concentration is 100%, it is determined that a non-negligible amount of water is contained in the ethanol if the quantity of fuel learned, detected or determined by the oxygen sensor located in front of a catalytic converter is greater than the predetermined reference value, for example, 5%. Accordingly, the water content is calculated from the map of water contents correlated with learned fuel quantities, which is constructed in advance through experimentation.

Here, the reason for determining that water is contained in the ethanol when the quantity of fuel learned, detected or determined by the oxygen sensor is greater than 5% is that even if the learned ethanol concentration is already 100% and so the basic quantity of fuel has already reached the maximum value of the air-fuel ratio to which it can be increased according to the ethanol concentration, the case where the quantity of fuel exceeds 5% of the basic fuel quantity can be determined to have occurred because a non-negligible amount of water is contained in the ethanol. Here the quantity of fuel has been fed back and learned to adapt the appropriate air-fuel ratio to the engine using the output value of the oxygen sensor.

For reference, in the water content determination step S30, the reference value to be compared with the quantity of fuel learned, detected or determined by the oxygen sensor may be set to a value ranging from about 3% to about 9%.

In the preliminary condition verification step S10, the ethanol learning conditions are set such that when the temperature of the coolant of the engine falls within a predetermined temperature range indicative of the normal operating state of the engine, and when the number of rotations of the engine is maintained in a steady state other than a state of either rapid acceleration or rapid deceleration, the ethanol learning conditions are determined to have been satisfied.

If the learned ethanol concentration is not 100% as a result of the ethanol determination step S20, and if the quantity of fuel learned, detected or determined by the oxygen sensor is equal to or less than the reference value as a result of the water content determination step S30, a fuel quantity learning step S50 is performed in which the quantity of fuel is normally learned.

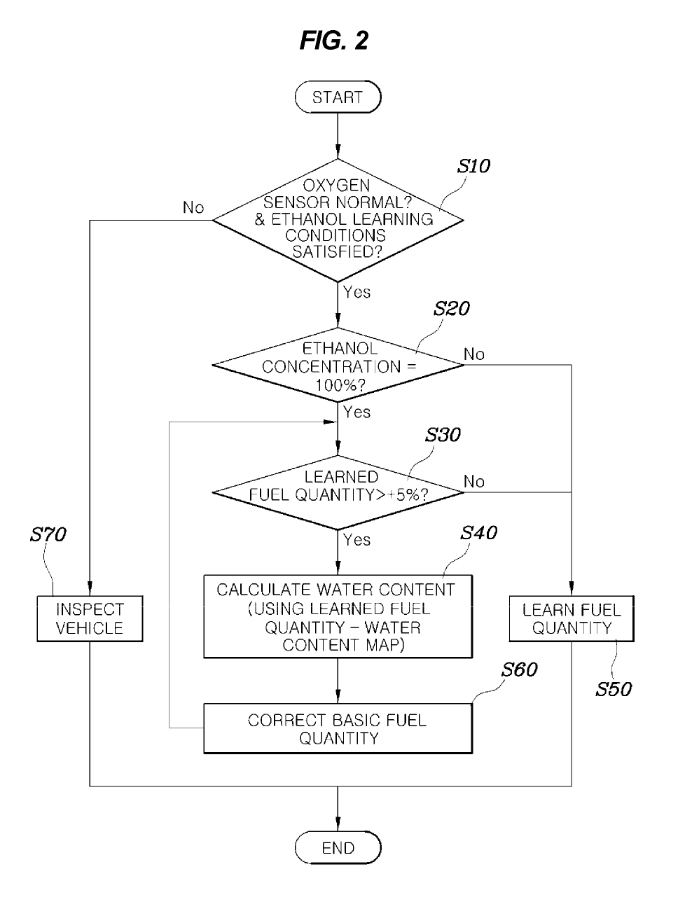

FIG. 2 is a flowchart illustrating a method of correcting the quantity of fuel based on the above-described method of determining the water content of ethanol according to the present application. The method includes a preliminary condition verification step S10, an ethanol determination step S20, a water content determination step S30, a water content calculation step S40, and a basic fuel quantity setting step S60. In step S10, whether an oxygen sensor is normal or abnormal is verified, and whether ethanol learning conditions have been satisfied is determined. In step S20, whether learned concentration of the ethanol is 100% is determined. In step S30, in the case where the oxygen sensor is normal, the ethanol learning conditions have been satisfied, and the ethanol concentration is 100%, it is determined that water is contained in the ethanol if the quantity of fuel learned, detected or determined by the oxygen sensor is greater than a predetermined reference value. In step S40, if it is determined in the water content determination step S30 that water is contained in the ethanol, water content corresponding to the learned quantity of fuel is obtained from a map of water contents correlated with learned fuel quantities. In step S60, the water content calculated in the water content calculation step S40 is compared with a map of basic fuel quantities corresponding to water contents, so that the basic quantity of fuel corresponding to the water content calculated in the water content calculation step S40 is obtained, and the fuel is injected based on the basic fuel quantity.

That is, if the water content of the ethanol has been calculated using the method of determining the water content of the ethanol that includes the preliminary condition verification step S10, the ethanol determination step S20, the water content determination step S30, and the water content calculation step S40, the basic quantity of fuel corresponding to the calculated water content is obtained based on the map of basic fuel quantities corresponding to water contents. Here, the map is constructed in advance through experimentation. Then the fuel is injected into the engine on the basis of the obtained basic fuel quantity, so that the water content is compensated.

In this case, the basic fuel quantity is the quantity of fuel that is set basically by the engine in conformity with the air-fuel ratio. With respect to the basic fuel quantity, the learned fuel quantity that has been fed back by the oxygen sensor is additionally subtracted or added, thus enabling feedback control for actual fuel injection to be performed. Therefore, the fact that the basic fuel quantity is differently set in the basic fuel quantity setting step S60 means that the basic air-fuel ratio is changed.

After the basic fuel quantity setting step S60, may repeatedly perform the water content determination step S30, so that the water content of the ethanol is continuously determined and calculated, and the basic quantity of fuel can be corrected based on the water content.

If it is determined in the preliminary condition verification step S10 that the oxygen sensor is abnormal, a warning prompting the inspection of a relevant vehicle is provided, and the control process is terminated in step S70.

As described above, the present application can estimate the water content of the ethanol and correct the basic quantity of fuel to be injected based on the water content, thus ensuring the stable operating state of the engine, suppressing an undesirable increase in the discharge of harmful substances, and preventing the malfunction of an engine monitoring system.

Accordingly, the present application is advantageous in that it determines the water content of ethanol, corrects the quantity of fuel based on the water content, and is capable of obtaining an appropriate air-fuel ratio substantially adapted to an engine, so that the soft operability of the engine can be ensured, the discharge of harmful substances can be reduced, and misdiagnoses can be prevented from occurring in a procedure for monitoring a fuel system, thus improving the reliability and marketability of the FFV.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of determining water content of ethanol for a Flexible Fuel Vehicle (FFV), comprising:
a) verifying whether an oxygen sensor is normal or abnormal, and determining whether ethanol learning conditions have been satisfied;
b) determining whether learned concentration of ethanol is 100%;
c) if the oxygen sensor is normal, the ethanol learning conditions are satisfied, and the ethanol concentration is 100%, determining that water is contained in the ethanol when a quantity of fuel learned by the oxygen sensor is greater than a predetermined reference value; and
d) if it is determined in c) that water is contained in the ethanol, calculating water content corresponding to the learned quantity of fuel from a map of water contents correlated with learned fuel quantities.

2. The method according to claim 1, wherein in a), the ethanol learning conditions are determined to have been satisfied when temperature of a coolant of the engine falls within a predetermined temperature range indicative of a normal operating state of the engine and a number of rotations of the engine is maintained in a steady state other than a state of either rapid acceleration or rapid deceleration.

3. The method according to claim 1, further comprising:
if it is determined in b) that the learned ethanol concentration is not 100%, and if it is determined in c) that the quantity of fuel learned by the oxygen sensor is equal to or less than the predetermined reference value, performing normal learning of the quantity of fuel.

4. A method of determining water content of ethanol for a Flexible Fuel Vehicle (FFV) and correcting fuel quantity based on the water content, comprising:
a) verifying whether an oxygen sensor is normal or abnormal, and determining whether ethanol learning conditions have been satisfied;
b) determining whether learned concentration of ethanol is 100%;
c) if the oxygen sensor is normal, the ethanol learning conditions are satisfied, and the ethanol concentration is 100%, determining that water is contained in the ethanol when a quantity of fuel learned by the oxygen sensor is greater than a predetermined reference value;
d) if it is determined in c) that water is contained in the ethanol, calculating water content corresponding to the learned quantity of fuel from a map of water contents correlated with learned fuel quantities; and
e) comparing the water content calculated in d) with a map of basic fuel quantities correlated with water contents, obtaining a basic quantity of fuel corresponding to the water content calculated in d), and injecting the fuel based on the basic quantity of fuel.

5. The method according to claim 4, wherein:
if it is verified in a) that the oxygen sensor is abnormal, a warning prompting inspection of a vehicle is provided and control is terminated, and
in a), the ethanol learning conditions are determined to have been satisfied when temperature of a coolant of the engine falls within a predetermined temperature range indicative of a normal operating state of the engine and a number of rotations of the engine is maintained in a steady state other than a state of either rapid acceleration or rapid deceleration.

6. The method according to claim 4, further comprising:
if it is determined in b) that the learned ethanol concentration is not 100%, and if it is determined in c) that the quantity of fuel learned by the oxygen sensor is equal to or less than the predetermined reference value, performing learning of the quantity of fuel using an output value of the oxygen sensor.

7. The method according to claim 4, wherein the predetermined reference value with which the quantity of fuel learned by the oxygen sensor is to be compared in c) is set to a value ranging from about 3% to about 9%.

8. The method according to claim 4, wherein, after e), c) is repeatedly performed to continuously determine and calculate the water content of the ethanol, and then the basic quantity of fuel is corrected based on the water content.
